(19) United States
(12) Patent Application Publication
(10) Pub. No.: US 2004/0216650 A1
(43) Pub. Date: Nov. 4, 2004

(54) Structure of delivery door having anti-theft security means

(76) Inventors: Jin-Kook Lee, Pusan (KR); Sung-Hae Lee, Pusan (KR)

Correspondence Address: ST. ONGE STEWARD JOHNSTON & REENS, LLC, 986 BEDFORD STREET, STAMFORD, CT, 06905-5619, US

(21) Appl. No.: 10/449,041

(22) Filed: May 29, 2003

Related U.S. Application Data
(63) Continuation of application No. PCT/KR00/01403, filed on Dec. 1, 2000.

(51) Int. Cl. E06B 7/32

(52) U.S. Cl. 109/19

(57) ABSTRACT

The present invention relates to a delivery door having anti-theft security means, more particularly to a door structure consists of a pair of casings, area adjustable mounting plate, hinge means and actuation means, which are installed on an entrance door or a window for delivering articles or products thereof. A delivery door installed on an entrance door or a window comprise an outer casing (4) and an inner casing (5) pivotally mounted on hinge means (3, 8, 9, 10), actuation means (12, 13, 15, 16) associated with the outer casing (4) and the inner casing (5) for opening and closing operation of casings and the mounting plate (6) having area adjustable means between the outer casing (4) and the inner casing (5) is characterized in that the mounting plate (6) is rotatable while in the transporting operation which securely controlled by the actuation means.

### CROSS-REFERENCES TO RELATED APPLICATIONS

This application is a continuation of pending International Patent Application No. PCT/KR00/01403 filed Dec. 1, 2000, which designates the United States.

### BACKGROUND OF THE INVENTION

1. Field of the Invention

This present invention relates to a structure of delivery door having anti-theft security means more particularly to a door structure comprised of a pair of casings, a mounting plate, hinge means and actuation means cooperatively formed on a suitable location of entrance door or window for delivering or transporting articles or products thereof.

2. Description of the Related Art

Recently, there has been tremendous growth in the delivery business of small packages in accordance with the rapid increase of ordering amount via Internet-based retail, TV-home shopping or any other communication means. In order to receive the ordered parcels or gifts in safe way, a delivery door having the safe means attached on an entrance door is necessary for the safe final delivery whether the resident is at home or not. Although the resident is at home, a safe door for the delivery purpose is required in order to receive the delivered gift or articles without opening the entrance door because the resident usually want to protect himself without exposure from the unknown person. Furthermore, the deliveries of products are frequently attempted at the times when the residents are not at home. Depending on the business policies of delivery service, the delivery must then be attempted on a subsequent day or the package may be simply left on the recipient's door step. Each of these alternatives has disadvantages for the recipient and often make a trouble for the delivery service. In the case of the vacancy of resident, the delivered parcels or articles are also required to convey into the entrance door in order to prevent the lost of delivered product or the reattempt of delivery.

According to the prior art of structure related to a safe door in the connection with the delivery means, various structures can be found depending on the kind of product or the size of delivering product.

U.S. Pat. No. 4,909,052 shows a simple structure of delivery door having a shape of secure box or a safe housing attached on the entrance door for the delivery means. But this kind of structure is limited to pick-up article or relatively small size of mail package. Furthermore, the deposited product in the secure box is less safe under the action of theft and the shape of secure box is less compatible with the flat surface of the entrance door.

For the another security purpose, Masachika had devised a series of the security devices of delivery door for the after hour depository having a relatively complicate but the secure structure published on U.S. Pat. Nos. 4,573,416, 4,489,662 and 4,466,357. These kinds of structures are usually applicable in wall of bank or place required a special purpose of depository, for example the after hour depository of video tapes. The relatively larger volume of delivered product based on the conventional package is hard to apply the above-mentioned structure to an entrance door.

Therefore, the main embodiment of present invention is related to provide a delivery door having a simply structure of security means which is compatible to the flat shape of entrance door and to deliver products through the entrance door whether the resident is at home or not.

### SUMMARY OF THE INVENTION

This invention has been accomplished in a view of above-mentioned background and is intended to provide a simple structure of delivery door having a secure delivery means which can widely be applicable to an entrance door or a window depending on the purpose of delivery or transport.

Accordingly, the present invention provides a secure delivery tool for receiving articles or small packages whether the resident is at home or not. Especially, in the case of the resident is not at home, the present invention is proposed to devise a workable device as an automatic delivery door in cooperated with a monitoring system which installed in front of the entrance door.

In addition, the application of embodiment under the present invention is related to provide a mounting structure of flowering pot applicable to install on window frame for transporting a flowering pot from outdoor to indoor or adversely without handing the mounted flowering pot on the mounting plate.

### BRIEF DESCRIPTION OF THE DRAWINGS

The foregoing and other objects, aspects, and advantages will be better understood from the following detailed description of preferred embodiments of the invention with reference to the drawings, in which:

FIG. 1 is related to a perspective view of generic embodiment according to the present invention.

FIG. 2 is a separate perspective view of an embodiment of hinge means according to the present invention.

FIG. 3 shows a perspective view of a combined structure of FIG. 2.

FIG. 4 is an upper cross sectional view of FIG. 3.

FIG. 4a to FIG. 4c are related to the schematic views of operational state of FIG. 2.

FIG. 5 is a perspective view of an embodiment of actuation means using bevel gears under the present invention.

FIG. 5a is a cross sectional view of FIG. 5.

FIG. 6a to FIG. 6c are related to the schematic views of operational state of FIG. 5.

FIG. 7 is a perspective view of another embodiment of actuation means using rack and pinion gear under the present invention.

FIG. 8a to FIG. 8c are related to the schematic views of operational state of FIG. 7.

FIG. 9 is related to a sectional view of locking means under the present invention.

FIG. 10a, 10b, 11 are related to illustrative views of the embodiment of present invention.

FIG. 12 shows a typical embodiment of present invention related to window frame.

### DETAILED DESCRIPTION OF THE DRAWINGS

Hereinafter, the preferred embodiments of delivery door according to the present invention will be described in detail with the references of accompanying drawings.

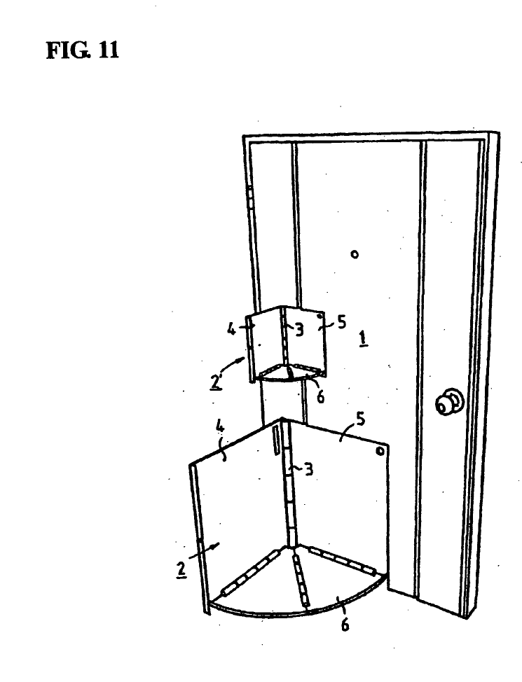

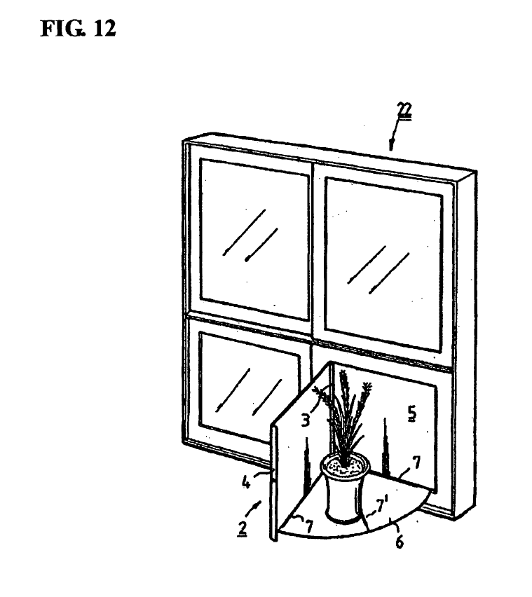

A delivery door according to the present invention is to install on a conventional entrance door 1 and to utilize the delivery door for delivering articles or transporting the delivered products more in a secure way without opening the entrance door 1. Conventionally, so as to deliver or dispatch relatively larger size of articles or products for the safety purpose, the present invention is desirable to install or to construct on the below part of the entrance door 1 as shown on FIG. 10a and FIG. 12. But the delivery door 2 under the present invention can be located at the appropriated position having the desirable size on the entrance door or window frame depending the usages.

The detail constitutions and embodiments related to the present invention will be described hereinbelow with the illustrative examples.

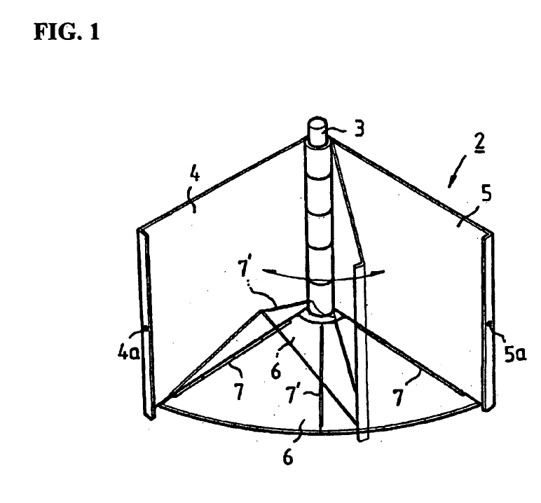

As shown on the FIG. 1, a delivery door of outer casing (4) and inner casing (5) are pivotally mounted on the hinge means (3), and are mutually linked each other by a mounting plate (6) associated with connecting pieces (7, 7′) thereon. The outer casing (4) and inner casing (5) formed on the outer and inner delivery door, which are pivoting independently about the hinge means (3), are configured on the part of entrance door (1) or window (22).

Between two pivoting casings (4) (5), a mounting plate (6) having the area adjustable means is provided. The mounting plate (6) alternatively can be comprised of foldable means or slidable means. As shown on the FIG. 10b, the foldable means of area adjustment related to the mounting plate (6) is constructed so as to fold in the upward direction while in the closing operation between the outer and inner casing in contrast to the downward direction for the unfolding of mounting plate (6) resulting the opening of the delivery door (2).

Although not shown on the figures, one can accomplish the embodiment of the area adjustment related to the mounting plate (6) using a linear combination of arc shaped slidable pieces resulting the area adjusting function of the mounting plate (6) while in the closing and opening of the delivery door. The mounting plate (6) cooperated with the pair of casings under the present invention play a vital role for the delivery means of articles maintaining the security purpose. The articles or delivered products put on the mounting plate (6) after opening the outer casing (4) moves into the inside of entrance door (1) by the pivotal motion of mounting plate resulting opening of the inner casing (5) into the inner side of the entrance door.

The pivotal motion of mounting plate (6) for the delivery operation into the inside of entrance door (1) can be accomplished by the manual operation at the location of the inside of entrance door by the host or the outside of door by the delivery man.

Simply the manual operation of delivery door by pulling the inner casing (5) into the inner direction by the host at the location of the inside entrance door makes the delivered products into the inside of entrance door (1). Also pushing operation of outer casing (5) by a delivery man after putting the articles on the mounting plate (6) completes the safe delivery process resulting the dosing operation of the outer casing (4) of the delivery door relative to the entrance door.

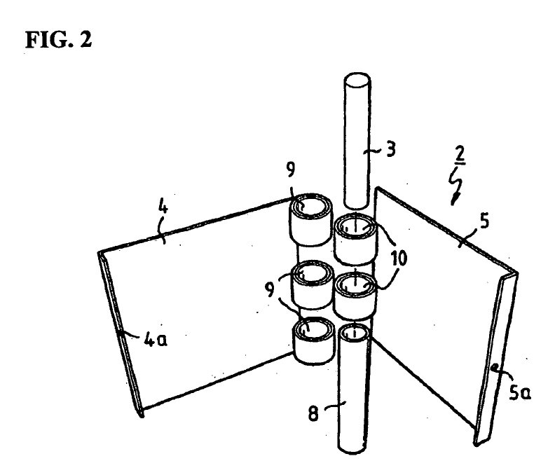

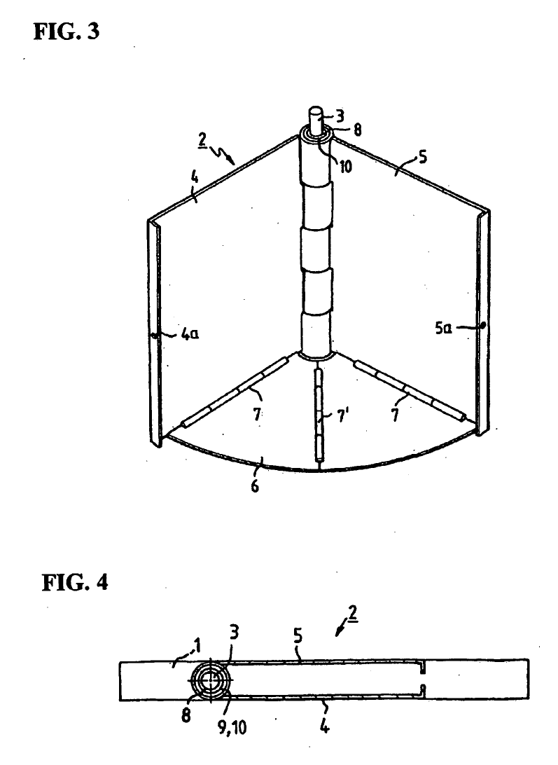

The pivotal motion of mounting plate (6) in connection with the safe delivery process in addition to the above mentioned manual operation can be applied in an advance way with the mutual operation of unidirectional bearing installed on the hinge means (3) as shown on the FIGS. 2 and 3.

Although not shown on the figures, the manual operation as an actuation means to the present invention can be further comprised a conventional mechanical device which can transform the pushing or pulling force exerted by foot into the rotational force of the casings.

According to another embodiment of hinge means (3), an inner unidirectional bearing (8) which rotate only into the clockwise direction is axially installed on the hinge means (3).

In addition to the inner unidirectional bearing (8) to the hinge mean (3), the outer unidirectional bearings (9) (10) which rotate into anticlockwise direction in opposite to the unidirectional bearing (8) are insertably combined with the inner unidirectional and axially installed on the hinge means (3) in connection with the outer casing (4) and inner casing (5) respectively.

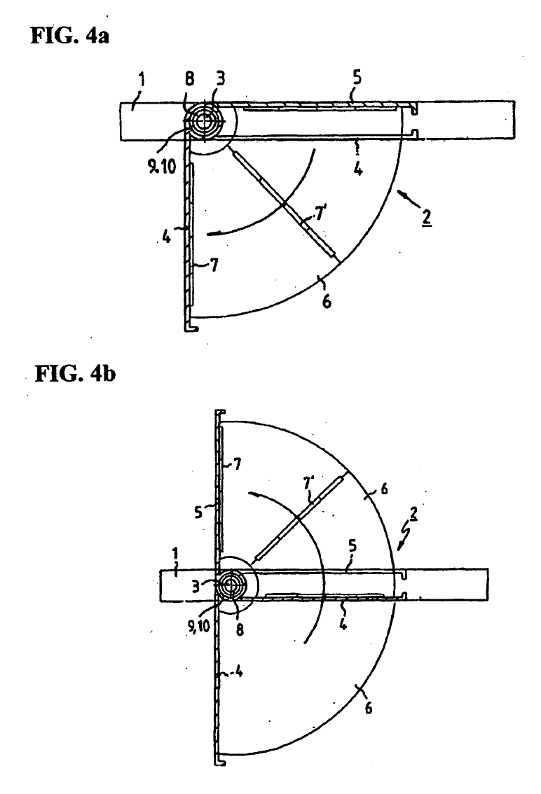

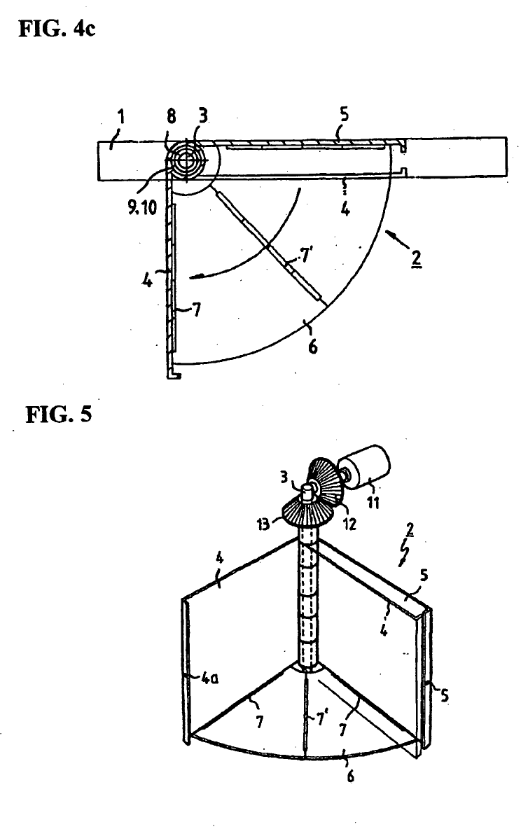

As also shown on the FIG. 4a to 4c, the pivotal motion of mounting plate (6) is accomplished with the embodiment of the unidirectional bearings.

Since the outer casing (4) is combined with the outer unidirectional bearing (9) only workable to the anticlockwise direction of entrance door, the opening operation of outer casing (4) into the outer direction of entrance door (1) is actuated by the operation of the inner unidirectional bearing (8) which is operatable with the clockwise rotation resulting the unfolding operation of mounting plate (6).

Similarly to the operational mechanism of FIG. 1, the pivotal motion of mounting plate (6) for the delivery operation into the inside of entrance door (1) can be accomplished by the manual or foot operation at the location of the inside of entrance door by the host or the outside of door by the delivery man.

The manual or foot operation of delivery door (2) by pulling the inner casing (5) into the inner direction by a host at the location of the inside entrance door makes the delivered product into the inside of entrance door (1) resulting the actuation of the outer unidirectional bearing (9) connected to the outer casing (4).

Also a pushing operation of outer casing (5) by a delivery man after putting the articles on the mounting plate (6) completes the safe delivery process resulting the closing operation of outer casing (4) of the delivery door relative to the entrance door resulting the actuation of outer unidirectional bearing (10) connected to inner casing (5).

The embodiment of area variation related to the mounting plate (6) in cooperation with the closing and opening operation of delivery door (2) can be applied to the embodiment of the unidirectional bearing in the same way as described with the FIG. 1.

Without changing the generic embodiment of present invention, the present structure can be also widely applied with the constitutions related to the mechanical apparatus which can be an actuation means.

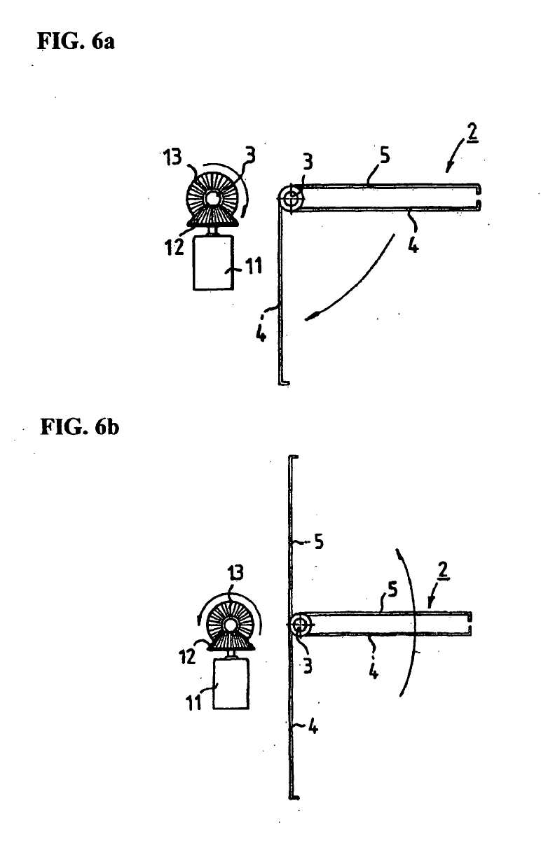

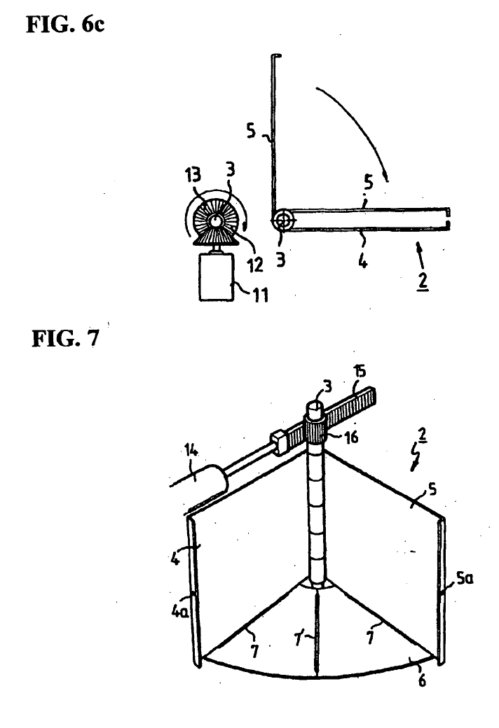

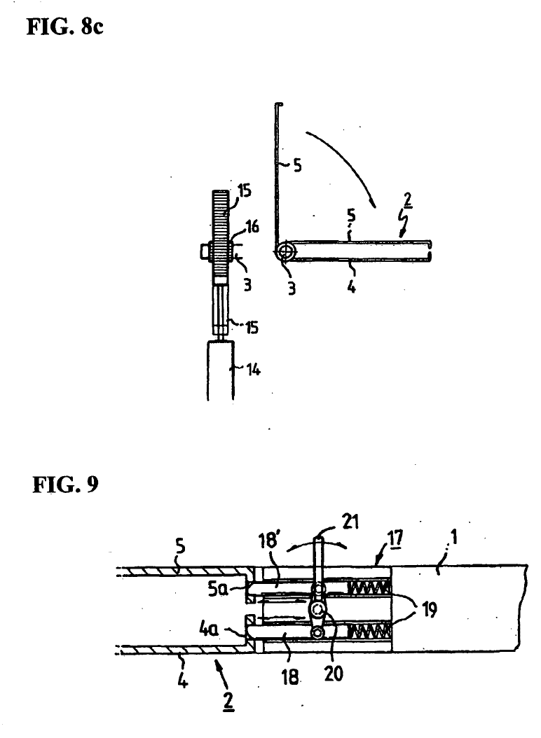

FIG. 5 and FIG. 7 are related to the embodiments of electric driving apparatus for opening and closing the delivery door (2). The detail configuration and mechanism for the operation with the mechanical apparatus will be described hereinbelow.

As shown on the FIG. 5, the outer casing (4) is fixedly installed on the hinge means (3) and an axial bevel gear (13) installed on the axis of hinge means (3) is operated by the tooth wheel gearing with the driving bevel gear (12) which is driven by the electric motor (11). But the inner casing (5) is freely installed on the hinge means (3) so that it can be rotated by the rotational torque of the mounting plate (6) or the manual operation.

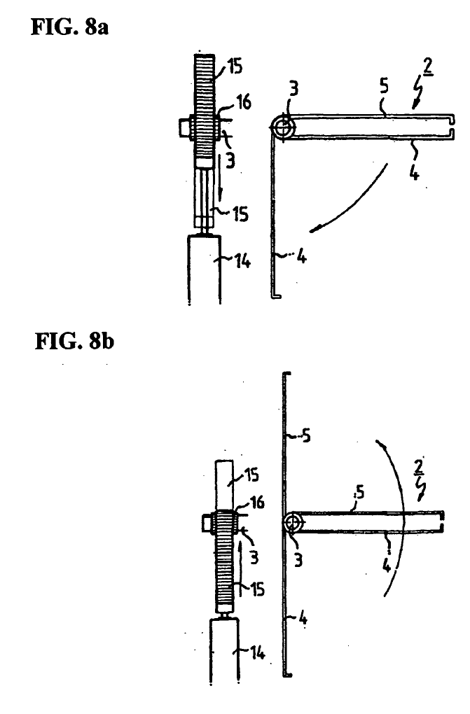

As illustrated on the FIG. 6a to 6c, the rotational motion of driving bevel gear (12) driven by the electric motor (11) actuates the opening operation of the outer casing (4) for the delivery. The rotational tooth wheel gearing between the driving gear (12) and axial bevel gear (13) provides the sequential rotation of the outer casing (4) which is fixed installed on the hinge means (3) resulting the unfolding operation of mounting plate (6). For the closing operation of outer casing (4), it is reversely related to the rotational motion of bevel gears (13), (14) comparing with the opening operation of the casing (4). Since the inner casing (15) is freely installed on the hinge means (3), the pivotal motion of mounting plate (6) exerted by the reverse rotation of cogwheels provide the rotational motion of inner casing (5) resulting the opening of inner casing (5) into the inner side of the entrance door.

Accordingly, the articles or delivered products on the mounting plate (6) are delivered into the inner side of the entrance door by the mechanical apparatus in the more convenient way. At the end, the closing operation for the inner casing (5) is done by the manual operation resulting the folding operation of mounting plate (6) in the same way.

FIG. 7 shows another embodiment related to the mechanical apparatus of rack (15) and pinion gear (16). The outer casing (4) is fixedly installed on the hinge means (3) and an axial pinion gear (16) installed on the axis of hinge means (3) is operated by the tooth wheel gearing with the rack gear (15) which is driven by the driven cylinder (14). But the inner casing (5) is freely installed on the hinge means (3) so that it can be rotated by the rotational torque of the mounting plate (6) or the manual operation.

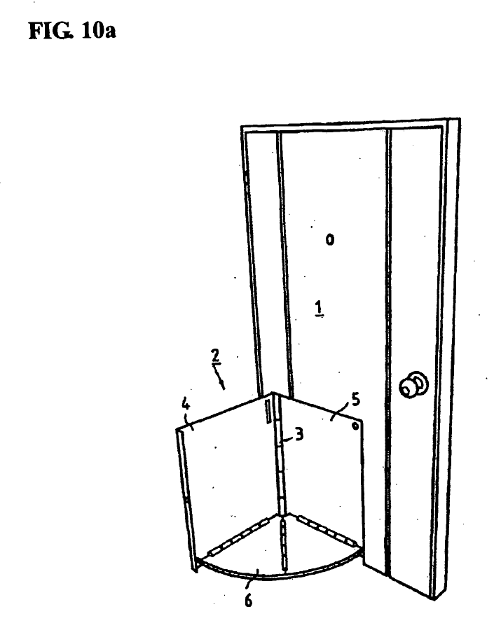

As illustrated on FIG. 8a to 8c, the linear motion of rack gear (15) driven by the driven cylinder (14) actuates the opening operation of the outer casing (4) for the delivery. The linear tooth wheel gearing between the rack gear (15) and pinion gear (16) provides the sequential rotation of the outer casing (4) which is fixed installed on the hinge means (3) resulting the unfolding operation of mounting plate (6). For the closing operation of outer casing (4), it is reversely related to the rotational motion of pinion gear (16) comparing with the opening operation of the casing (4). Since the inner casing (15) is freely installed on the hinge means (3), the pivotal motion of mounting plate (6) exerted by the reverse rotation of cogwheels provide the rotational motion of inner casing (5) resulting the opening of inner casing (5) into the inner side of the entrance door.

Accordingly, the articles or delivered products on the mounting plate (6) are delivered into the inner side of the entrance door by the mechanical apparatus in the more convenient way. Finally, the closing operation for the inner casing (5) is done by the manual or foot operation resulting the folding operation of mounting plate (6) as described on the above-mentioned illustrations.

In cooperation with the monitoring system installed in front of the delivery door, a conventional electrical circuit of switching operation for driving the tooth wheel gearing apparatus is enable to deliver even though the vacancy of person in the house.

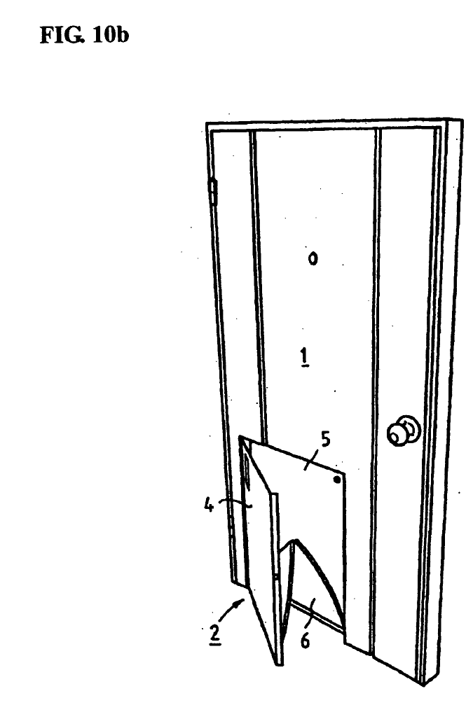

In addition to the constitution, a locker 17 of locking means for the outer casing (4) and the inner casing (5) can be formed for the safety reason. As shown on the FIG. 9, a locker (17) is comprised of the biased the locking pin (17, 17′) by the resilient force caused by the coil spring (19) for locking onto the locking holes (17, 18′). At the center of the locking pin (18, 18′), the operating lever (21) related to the bilateral arc motion actuates the locking or unlocking operation in the alternative way or in the simultaneous way. Besides the above-mentioned locking means, various conventional locking techniques can be applied depending on the requirements.

Another useful application of the generic embodiment of present invention is related to the applicable installation to the part of window as shown on FIG. 12.

The mounting plate (6) co-operated with a pair of casings (4) (5) under the present invention plays a role for the delivery means of flowering pot maintaining the security purpose of this invention.

Of course, the outer casing (4) and inner casing (5) can be made of the window materials having the transparent property. For the cultivation purpose of flowering pot, the present invention is very useful in that the mounting plate (6) can be utilized the delivery means for transporting the flowering pot from the outside window to the inside place according to the requirements.

The flowering pot on the mounting plate (6) between the outer casing (4) and the inner casing (5) can be exposed conveniently to the sunlight or the raining environment and returns to the inside position for the purpose of the interior decoration without disturbing the window's function of guard shield.

### INDUSTRIAL APPLICABILITY

The industrial utilization of delivery door under the present invention is greatly promoted in order to meet the requirements of tremendous growth in the delivery business of small packages in accordance with the rapid increase of ordering amount via Internet-based retail, TV-home shopping or any other communication means.

As shown on the typical utilization of transporting a flowering pot, the application of present structure is applicable to a window frame besides the entrance door. Especially, in the case of the resident is not at home, the present invention is also a useful devise to set an automatic delivery door in cooperated with a monitoring system which installed in front of the entrance door.

While the invention has been described in terms of a few preferred embodiments, those skilled in the art will recognize that the invention can be practiced with modification within the spirit and scope of the appended claims.

What is claimed is:

1. A delivery door of an entrance door or a window comprising;
said outer casing (4) and said inner casing (5) pivotally mounted on said hinge means (3),
said actuation means associated with said outer casing (4) and said inner casing (5) for opening and closing operation of said casings,
said mounting plate (6) having area adjustable means between said outer casing (4) and said inner casing (5) is characterized in that said mounting plate (6) is rotatable while in the delivering operation.

2. A delivery door defined in claim 1, wherein said area adjustable means characterized by the foldable operation of two arc shaped plates having the connecting piece (7′).

3. A delivery door defined in claim 1, wherein said area adjustable means characterized by the slidable operation of a plurality of arc shaped pieces having connecting pieces.

4. A delivery door defined in claim 1, wherein said actuation means characterized by the manual or foot operation.

5. A delivery door defined in claim 1, wherein said actuation means characterized by the tooth wheel gearing between rack (15) gear and pinion gear (16).

6. A delivery door defined in claim 1, wherein said actuation means characterized by the tooth wheel gearing between the driving bevel gear (12) and axial bevel gear (13).

7. A delivery door defined in claim 1, characterized by the fact that said monitoring system in front of said delivery door is cooperated for actuating operation of said actuation means.

8. A delivery door defined in claim 1, characterized by the fact that the locking means having said biased locking pin (17, 17′) by the resilient force and said operating lever (21) related to the bilateral arc motion actuates the locking or unlocking operation in the alternative way or in the simultaneous way.

9. A delivery door defined in claim 1, wherein said hinge means further comprising said inner unidirectional bearing (8) to the hinge axis and said outer unidirectional bearings (9) (10) which rotates into anticlockwise direction on the opposite way to said unidirectional bearing (8) are insertably combined on the hinge axis in connection with said outer casing (4) and said inner casing (5) respectively.

10. A delivery door defined in claim 1, characterized by the fact that the structure is applied for window frame in order to transport flowering pot mounted on the mounting plate (6) between the inner (4) and outer casing (5).
